(19) United States
(12) Patent Application Publication
(10) Pub. No.: US 2011/0147980 A1
(43) Pub. Date: Jun. 23, 2011

(54) INJECTION MOLDING OF TOUCH SURFACE

(76) Inventors: Kuo-Hua SUNG, Sunnyvale, CA (US); Shin John Choi, Sunnyvale, CA (US)

(21) Appl. No.: 12/985,261

(22) Filed: Jan. 5, 2011

Related U.S. Application Data
(62) Division of application No. 12/641,169, filed on Dec. 17, 2009.

(51) Int. Cl. B29C 45/14; B29C 45/17; B29C 43/18

(52) U.S. Cl. 264/129; 264/275; 264/254; 264/279.1

(57) ABSTRACT

Injection molding for a touch surface of a touch sensitive device is disclosed. A single-shot injection molding method can include molding an injected material to encapsulate a touch sensor at a substantially uniform distance from a touch surface of the molded material. A double-shot injection molding method can include molding a first shot of an injected material to contact a portion of a touch sensor and molding a second shot of an injected material to encapsulate at least the remaining portions of the touch sensor to form a touch surface at a substantially uniform distance from the touch sensor. Another molding method can include molding a coating on a touch sensor to having a substantially uniform thickness. The injection molded material can provide a substantially uniform capacitive dielectric for the device. The injection molded touch surface can be incorporated into an electronic mouse, a mobile telephone, a digital media player, or a computer.

### CROSS-REFERENCE TO RELATED APPLICATIONS

This application is a divisional of U.S. patent application Ser. No. 12/641,169, filed Dec. 17, 2009, the entire disclosure of which is incorporated herein by reference.

### FIELD

This relates generally to touch surfaces and, more particularly, to an injection molded touch surface having a touch sensor encapsulated therein.

### BACKGROUND

Touch sensitive devices are increasingly used as input devices to a computing system. Generally, a touch sensitive device can include a touch surface to input information via touch and a touch sensor for sensing the touch on the surface. Conventional fabrication of touch sensitive devices can involve laminating the touch sensor to the touch surface using an adhesive. This approach can be problematic, however. Bubbles or voids can form between the touch sensor and the touch surface during lamination and can cause irregular capacitive dielectric between the touch sensor and an object touching the touch surface, thereby making consistent touch sensing difficult. Additionally, treating the touch surface with a primer prior to lamination may be needed to ensure proper adhesion, thereby lengthening fabrication cost and time. When the touch surface is curved or non-planar, these problems can exacerbate.

### SUMMARY

This relates to injection molding for a touch surface of a touch sensitive device to provide a substantially uniform dielectric between the touch surface and a touch sensor encapsulated therein. A single-shot injection molding method can include positioning a touch sensor inside a mold, injecting a moldable material into the mold around the positioned touch sensor, and molding the injected material to encapsulate the touch sensor at a substantially uniform distance from a surface of the molded material. A double-shot injection molding method can include positioning a touch sensor inside a mold to have a substantially uniform distance from an interior surface of the mold, injecting a first shot of a moldable material into the mold, molding the first shot to contact at least a portion of the touch sensor, injecting a second shot of a moldable material into the mold, and molding the second shot to contact at least the remaining portion of the touch sensor so as to encapsulate the touch sensor. Another molding method can include coating a touch sensor with a moldable material, positioning the coated touch sensor inside a mold, and molding the material to have a substantially uniform thickness on the touch sensor. Injection molding can advantageously provide more consistent touch sensing and reduce fabrication cost and time.

### BRIEF DESCRIPTION OF THE DRAWINGS

FIGS. 1a-1c illustrate a three-dimensional view, a plan view, and a cross-sectional view, respectively, of an exemplary touch sensitive device having an injection molded flat touch surface with an encapsulated touch sensor according to various embodiments.

FIGS. 2a-2c illustrate a three-dimensional view, a plan view, and a cross-sectional view, respectively, of an exemplary touch sensitive device having an injection molded curved touch surface with an encapsulated touch sensor according to various embodiments.

FIG. 3 illustrates an exemplary method for single-shot injection molding of a touch surface with an encapsulated touch sensor according to various embodiments.

FIG. 4 illustrates an exemplary method for double-shot injection molding of a touch surface with an encapsulated touch sensor according to various embodiments.

FIG. 5 illustrates an exemplary method for molding of a touch surface with an encapsulated touch sensor according to various embodiments.

FIG. 6 illustrates an exemplary mouse having an injection molded touch surface with an encapsulated touch sensor pad according to various embodiments.

FIG. 7 illustrates an exemplary mobile telephone having an injection molded touch surface with an encapsulated touch sensor panel according to various embodiments.

FIG. 8 illustrates an exemplary digital media player having an injection molded touch surface with an encapsulated touch sensor panel according to various embodiments.

FIG. 9 illustrates an exemplary computer having an injection molded touch surface with an encapsulated track pad according to various embodiments.

### DETAILED DESCRIPTION

In the following description of various embodiments, reference is made to the accompanying drawings which form a part hereof, and in which it is shown by way of illustration specific embodiments which can be practiced. It is to be understood that other embodiments can be used and structural changes can be made without departing from the scope of the various embodiments.

This relates to injection molding for a touch surface of a touch sensitive device to provide a substantially uniform dielectric between the touch surface and a touch sensor encapsulated therein. A single-shot injection molding method can include positioning a touch sensor inside a mold, injecting a moldable material into the mold around the positioned touch sensor, and molding the injected material to encapsulate the touch sensor at a substantially uniform distance from a surface of the molded material. A double-shot injection molding method can include positioning a touch sensor inside a mold to have a substantially uniform distance from an interior surface of the mold, injecting a first shot of a moldable material into the mold, molding the first shot to contact at least a portion of the touch sensor, injecting a second shot of a moldable material into the mold, and molding the second shot to contact at least the remaining portion of the touch sensor so as to encapsulate the touch sensor. Another molding method can include coating a touch sensor with a moldable material, positioning the coated touch sensor inside a mold, and molding the material to have a substantially uniform thickness on the touch sensor.

Using injection molding to provide a substantially uniform dielectric between a touch surface and an encapsulated touch sensor of a touch sensitive can advantageously provide more consistent touch sensing and reduce fabrication cost and time.

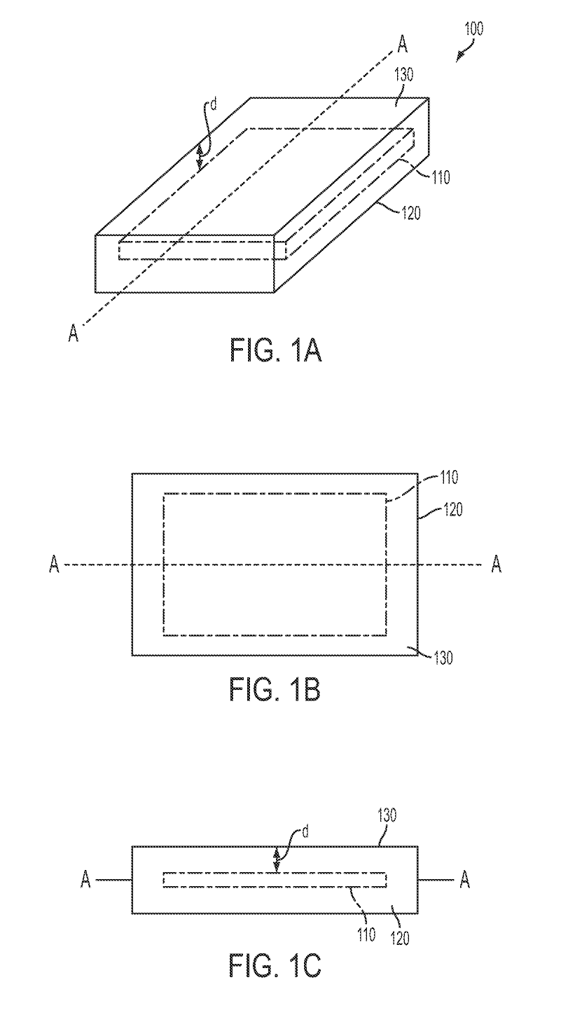

FIGS. 1a-1c illustrate a three-dimensional view, a plan view, and a cross-sectional view, respectively, of an exemplary touch sensitive device having an injection molded flat touch surface with an encapsulated touch sensor according to various embodiments. In the example of FIG. 1a, touch sensitive device 100 can include body 120 with touchable surface 130 and touch sensor 110. The device 100 can be formed by injection molding, where the touch sensor 110 can be positioned inside an injection mold and moldable material forming the body 120 can be injected into the mold around the sensor. The injection mold can have the desired shape of the device body 120. The injected material can conform to the mold shape and encapsulate the touch sensor 120. The injected material can then be cured to form the device body 120 that has the touchable surface 130 and that encapsulates the touch sensor 110.

The injected material can be plastic, acrylic, foam, epoxy, and/or the like. Generally, the injected material can be any moldable material, in various embodiments, being one or more of low cost, nonconductive, low dielectric constant, and low molding temperature and pressure. The touch sensor 110 can include a substrate of polyimide, other polycarbonates, and/or the like, with conductive traces of copper, silver, indium tin oxide (ITO), and/or the like, formed thereon for touch sensing. Generally, the touch sensor 110 can include any material that is flexible, resistant to injection molding temperatures and pressures, and capable of touch sensing.

The injection molding process can be controlled such that the encapsulated sensor 110 can lie at a substantially uniform distance d from the touchable surface 130 of the body 120. This can be done by forming a substantially uniform thickness d of the injected material on the touch sensor 110 substantially free of any voids, bubbles, or other imperfections either in the material or between the material and sensor. As a result, capacitive coupling between an object touching the touchable surface 130 and the touch sensor 110 can be consistent at any location on the surface. Additionally, the injected material can form a substantially uniform capacitive dielectric. Hence, the touch sensitive device 100 can advantageously provide consistent touch sensing.

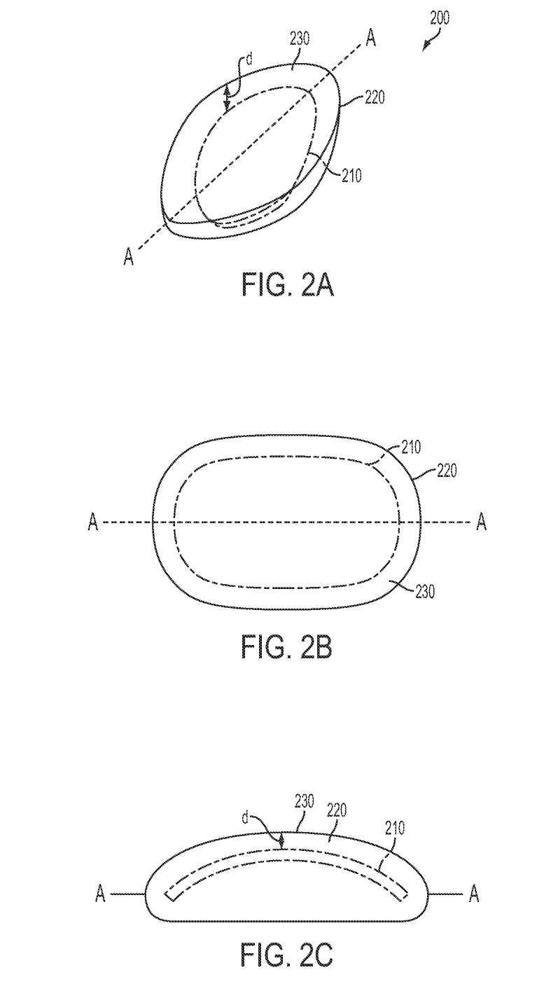

FIGS. 2a-2c illustrate a three-dimensional view, a plan view, and a cross-sectional view, respectively, of an exemplary touch sensitive device having an injection molded curved touch surface with an encapsulated touch sensor according to various embodiments. In the example of FIGS. 2a-2c, touch sensitive device 200 can include body 220 with touchable surface 230 and touch sensor 210. Similar to the device 100 of FIGS. 1a-1c, the touch sensitive device 200 can be formed by injection molding to have the body 220 with the touchable surface 230 and the encapsulated touch sensor 210. Here, the touchable surface 230 can be curved and the encapsulated touch sensor 210 can also be curved to conform to the shape of the touchable surface. The touch sensor 210 can lie at a substantially uniform distance d from the touchable surface 230, with the injected material forming a substantially uniform thickness d on the sensor.

It is to be understood that other shapes are also possible for the touchable surface and the encapsulated touch sensor to conform thereto according to various embodiments.

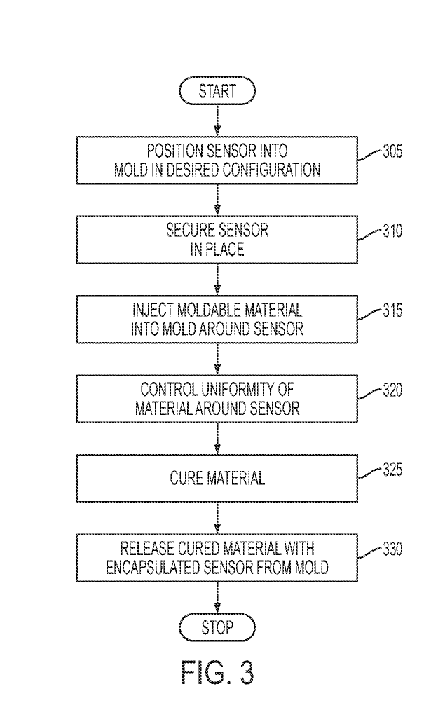

FIG. 3 illustrates an exemplary method for single-shot injection molding of a touch surface with an encapsulated touch sensor according to various embodiments. In the example of FIG. 3, an injection mold having a shape of a desired touch sensitive device can be provided. A touch sensor can be positioned in the mold in a desired configuration so that the touch sensor is a substantially uniform distance from at least one interior surface of the mold (305). Preferably, this interior surface can be the surface that molds the touchable surface of the touch sensitive device. For example, for a flat touchable surface, the touch sensor can be positioned to lie flat inside the mold at a substantially uniform distance from the mold's interior flat surface that forms the touchable surface. For a curved touchable surface, the touch sensor can be positioned to curve inside the mold at a substantially uniform distance from the mold's interior curved surface that forms the touchable surface. For a randomly shaped touchable surface, the touch sensor can be positioned to match the random shape inside the mold at a substantially uniform distance from the mold's interior randomly shaped surface that forms the touchable surface. The touch sensor can be rigid, semi-rigid, or flexible, depending on the needs of the touch sensitive device. Preferably, the touch sensor can be flexible to work with many different touch surface shapes.

The touch sensor in the desired configuration can be secured in place inside the mold so that the sensor does not move during subsequent processing (310). The touch sensor can be secured in various ways, such as pins, sliders, lifters, hooks, vacuum, and so on. In some embodiments, the touch sensor can be secured only on its undersurface so that the top surface (i.e., the surface closest to the device's touchable surface) can have a continuous covering of injected material without holes at securing locations caused by the securing tools. In additional or alternatively, the touch sensor can be secured at its sides for similar reasons. Having the continuous covering of injected material can help ensure the consistent capacitive coupling and substantially uniform dielectric described previously.

A shot (i.e., an amount sufficient to fill the mold) of moldable material for forming the body of the touch sensitive device can be injected into the mold around the touch sensor (315). The shot can be controlled so that the injected material can form a touchable surface that is a substantially uniform distance from the touch sensor (320). The control can also ensure that the touch sensor does not move during injection, that the injected material encapsulates the touch sensor while conforming to the mold, and that there are few or no voids, bubbles, or other imperfections in the formed body. Various parameters of the shot can be controlled, such as its temperature, pressure, flow, and so on. In some embodiments, control can be performed by a microprocessor controller.

The injected material can be cured, for example, by air or fluid cooling, to harden the injected material (325). The cured material with the encapsulated touch sensor can be released from the mold for further processing (330). In some embodiments, a protective coating can be applied over the cured material after release from the mold. In some embodiments, an anti-reflective layer can be applied over the cured material after release from the mold.

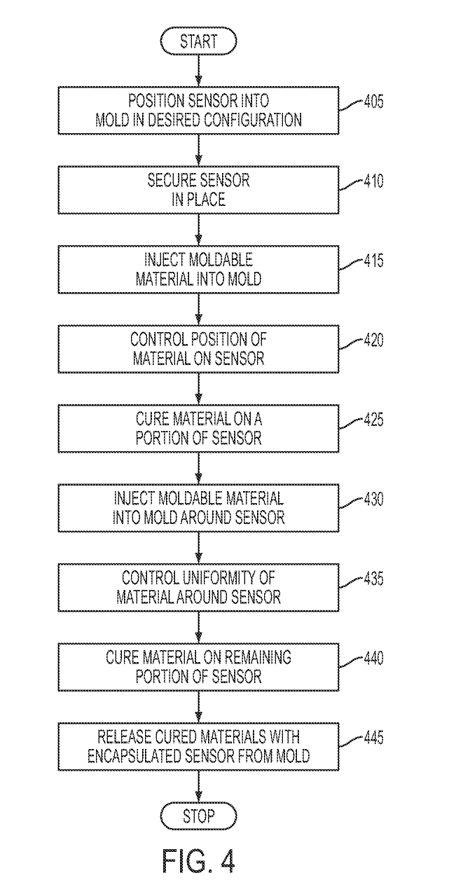

FIG. 4 illustrates an exemplary method for double-shot injection molding of a touch surface with an encapsulated touch sensor according to various embodiments. In the example of FIG. 4, an injection mold having a shape of a desired touch sensitive device can be provided. A touch sensor can be positioned inside the mold in a desired configuration in which the touch sensor lies at a substantially uniform distance from at least one interior surface of the mold (405). The interior surface of the mold can be the surface used to form the touchable surface of the touch sensitive device. The touch sensor in the desired configuration can be secured in place by the various ways described previously, for example (410).

A first shot of moldable material can be injected into the mold (415). The shot can be controlled so that it is injected at a particular position of the mold (420). For example, the shot can be controlled to contact only a portion of the touch sensor to form a cosmetic or aesthetic layer on the touch sensor. The shot can also be controlled to form some portions of the touch sensitive device, e.g., some portion of the touch surface to be a substantially uniform distance from the touch sensor. The shot can also be controlled to avoid moving the touch sensor during injection and to avoid forming imperfections in the material or between the material and sensor. The injected material can be cured in a similar manner to that described previously (425).

A second shot of moldable material can be injected into the mold around the sensor (430). The second shot can be either the same material or a different material than the first shot, depending on the requirements of the touch sensitive device. The shot can be controlled so that the injected material has a touchable surface that is a substantially uniform distance from the touch sensor (435). The shot can also be controlled either to encapsulate the first cured shot along with the touch sensor or to bond with the first cured shot to complete encapsulation of the touch sensor. The temperature, pressure, flow, and the like can be controlled as described previously.

The injected material can be cured in a similar manner to that described previously (440). The cured device having a touchable surface and an encapsulated touch sensor can be released from the mold for further processing (445).

It is to be understood that additional shots can also be injected into the mold in a multi-shot process. It is further to be understood that the order of the injections can be changed so that the encapsulating shot can be injected first.

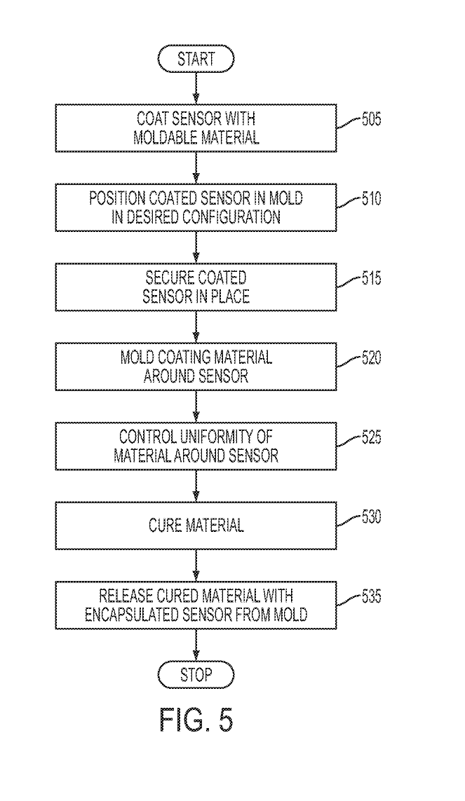

FIG. 5 illustrates an exemplary method for molding of a touch surface with an encapsulated touch sensor according to various embodiments. In the example of FIG. 5, a touch sensor can be coated with a moldable material (505). The thickness of the coating can be determined according to the requirements of the touch sensitive device. The coated touch sensor can be positioned inside an injection mold in a desired configuration so that the touch sensor is a substantially uniform distance from at least one interior surface of the mold (510). The injection mold can have the shape of a desired touch sensitive device and the interior surface of interest can be the surface that forms the touchable surface of the device. The coated sensor can be secured in place in the mold in a similar manner to that described previously (515).

The coating material can be molded around the touch sensor to conform to the mold shape (520). In some embodiments, additional coating material can be injected into the mold as needed. The molding can be controlled to ensure that the touch surface formed by the coating material is a substantially uniform distance from the touch sensor (525). Pressure on the coating material, heat applied thereto, and the like can be controlled to distribute the coating material around the touch sensor to encapsulate the sensor. The temperature, pressure, and flow of injected material, if any, can also be controlled.

The coating material can be cured in a similar manner to that described previously (530). The cured material with the encapsulated touch sensor can be released from the mold for further processing (535). In some embodiments, the cured material can be subjected to post-molding finishing to further adjust its thickness, as needed, to provide the desired thickness of the coating material on the touch sensor and hence the desired substantially uniform distance between the touch surface and the encapsulated touch sensor.

Additional methods to those of FIGS. 3-5 can also be used according to various embodiments.

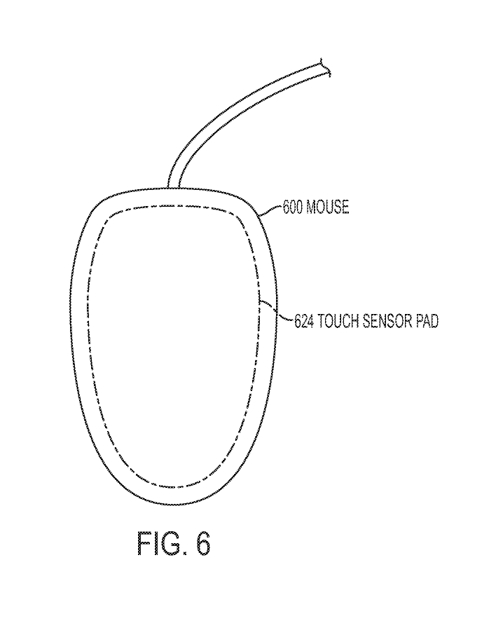

FIG. 6 illustrates an exemplary electronic mouse 600 that can have an injection molded touch surface with an encapsulated touch sensor pad 624 according to various embodiments.

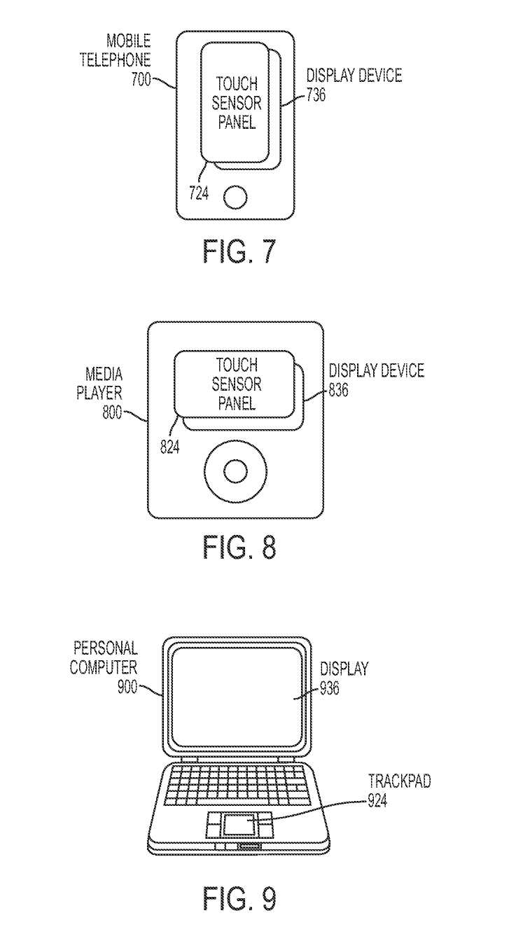

FIG. 7 illustrates an exemplary mobile telephone 700 that can include a display 736 and an injection molded touch surface with an encapsulated touch sensor panel 724 according to various embodiments.

FIG. 8 illustrates an exemplary digital media player 800 that can include a display 836 and an injection molded touch surface with an encapsulated touch sensor panel 824 according to various embodiments.

FIG. 9 illustrates an exemplary personal computer 900 that can include a display 936 and an injection molded touch surface with an encapsulated touch sensor panel (trackpad) 924 according to various embodiments.

The electronic mouse, mobile telephone, media player, and personal computer of FIGS. 6 through 9 can realize quality touch sensing performance by providing a touch surface with an encapsulated touch sensor formed from injection molding according to various embodiments.

Although embodiments describe touch sensors, it is to be understood that proximity and other types of sensors can also be used.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A method comprising:
positioning a touch sensor inside a mold;
injecting a moldable material into the mold around the positioned touch sensor; and
molding the injected material to encapsulate the touch sensor at a substantially uniform distance from a touchable surface of the molded material.

2. The method of claim 1, wherein positioning the touch sensor comprises positioning the sensor to conform to a shape of an interior surface of the mold at the substantially uniform distance from the interior surface.

3. The method of claim 1, wherein positioning the touch sensor comprises employing a securing mechanism to at least one surface of the touch sensor to secure the touch sensor in place.

4. The method of claim 1, wherein injecting the moldable material comprises controlling the material to avoid the material moving the touch sensor.

5. The method of claim 1, wherein injecting the moldable material comprises controlling at least one of flow, temperature, or pressure of the material.

6. The method of claim 1, wherein the moldable material comprises plastic.

7. The method of claim 1, wherein the touch sensor comprises a flexible polymer substrate and conductive traces thereon.

8. The method of claim 1, comprising applying a protective layer to the molded material.

9. The method of claim 1, comprising applying an anti-reflective layer to the molded material.

10. The method of claim 1, wherein molding the injected material comprises forming a thickness of the injected material on the touch sensor corresponding to the substantially uniform distance.

11. A method comprising:
positioning a touch sensor inside a mold to have a substantially uniform distance from an interior surface of the mold;
injecting a first shot of a moldable material into the mold;
molding the first shot to contact at least a portion of the touch sensor;
injecting a second shot of a moldable material into the mold; and
molding the second shot to contact at least the remaining portion of the touch sensor so as to encapsulate the touch sensor.

12. The method of claim 11, wherein molding the first shot comprises forming a cosmetic layer on the portion of the touch sensor.

13. The method of claim 11, wherein molding the second shot comprises forming a touchable surface to be the substantially uniform distance from the touch sensor.

14. The method of claim 11, wherein molding the second shot comprises encapsulating both the molded first shot and the touch sensor so as to form a touchable surface at the substantially uniform distance from the touch sensor.

15. The method of claim 11, wherein molding the second shot comprises bonding with the molded first shot to encapsulate the touch sensor so as to form a touchable surface at the substantially uniform distance from the touch sensor.

16. A method comprising:
coating a touch sensor with a moldable material;
positioning the coated touch sensor inside a mold; and
molding the material to have a substantially uniform thickness on the touch sensor.

17. The method of claim 16, wherein molding the material comprises controlling the thickness of the material so as to provide a substantially uniform dielectric between a surface of the molded material and the touch sensor.

18. The method of claim 16, wherein positioning the coated touch sensor comprises securing the touch sensor in the mold to be stationary during the molding.
